(19) United States
(12) Patent Application Publication
(10) Pub. No.: US 2007/0079227 A1
(43) Pub. Date: Apr. 5, 2007

(54) Processor for creating document binders in a document management system

(75) Inventors: Harpreet Singh, Orange, CA (US); Marianne Kodimer, Huntington Beach, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/197,045

(22) Filed: Aug. 4, 2005

(51) Int. Cl. G06F 17/00; G06F 3/00

(52) U.S. Cl. 715/500; 715/517; 715/769; 715/764

(57) ABSTRACT

A method and apparatus for manipulating an electronic document. Electronic document data representing pages to be rendered on an associated output device are received and displayed to a user as tiles. A user creates a binder document to which are added images of the pages of a document or documents. The user, via a graphical user interface, is able to selectively arrange the pages in the binder. Using drag and drop or cut and paste techniques, pages are copied from the original document or documents in a document management system and pasted into the binder. As the pages are placed in the binder, they are converted into an appropriate format, corresponding to a preselected binder format. The binder document is then capable of being stored, printed, viewed and managed as an individual document.

### BACKGROUND OF THE INVENTION

This invention is directed to a system and method for document management. More particularly, this invention is directed to a system and method for generating and managing documents in a document management system.

A document management system is typically a computer program that enables various users to create, store, track and manage a variety of electronic documents. In order for the various users to access and create documents, the document management system employs version control, keeping multiple copies of the document reflecting different users and editions. Such version control typically involves a version number or character designation. The documents stored on such a document management system are then capable of being viewed, edited, downloaded, and printed. However, in order to effectively manage documents, the system requires an outside application, such as Microsoft Word®, Microsoft Excel®, Corel WordPerfect®, or the like, to generate the documents. In addition, each user that accesses the document stored in the document management system must have the same software as the author.

Web-based document composition software typically allows a user to view and manipulate pages of an image file, such as PNG, TIFF, JPEG, MMR and the like. The manipulation generally includes the ability to print the pages. However, the web-based document composition software does not provide an intuitive user interface for the manipulation of images. Furthermore, the composition software lacks the ability to access and integrate such images in a document management system.

There is a need for a system and method for generating and managing electronic documents in a document management system.

### SUMMARY OF THE INVENTION

In accordance with the present invention, there is provided a system and method for document processing.

Still further, in accordance with the present invention, there is provided a system and method for generating and managing electronic documents in a document management system.

Still further, in accordance with the present invention, there is provided an electronic document processor. The processor includes receiving means that receive electronic document data representing a plurality of pages to be rendered on an associated output device. Displaying means are also included that display indicia representing the plurality of pages on an associated display. The processor also contains generating means that generate, image data representing a document binder. A user interface is included, which receives arrangement instructions relative to the assembly of the pages in the document binder from an associated user. The processor further includes display means, which generate a display image representing the assembly of pages in the document binder. The processor also comprises conversion means, which convert the assembled pages in the binder into binder data of a selected output format. In addition, the processor includes receiving means that function to receive document output instructions from the user and communication means that communicate the output data to an associated document rendering device in connection with the received document output instruction.

Still further, in accordance with the present invention, there is provided a method for manipulating an electronic document. The method begins by receiving electronic document data representing pages to be rendered on an associated output device. Indicia representing the pages are then displayed on an associated display. An image is then generated representing a document binder on the display. Arrangement instructions are then received from an associated user via a user interface. These instructions correspond to the arrangement of the pages in the binder. An image representing the arranged pages in the binder is then generated and the pages are converted into binder data of a selected document output format. Document output instructions are then received from the associated user and the output data is communicated to an associated document rendering device corresponding to the output instructions.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWING

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating a document binder composition method in accordance with the present invention; and

FIG. 3 is a template screen illustrating the document binder composition in accordance with the present invention.

### DETAILED DESCRIPTION OF THE PREFERRED EMBODIMENT

The present invention is directed to electronic document processing. More particularly, the present invention is directed to a system and method for composing, viewing, and manipulating one or more files, grouped together as a single entity.

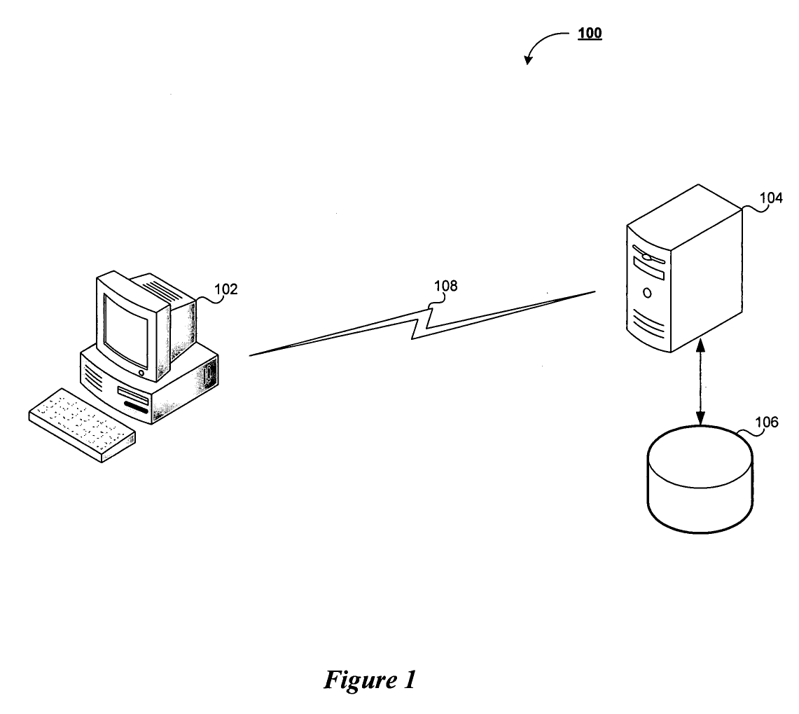

Turning now to FIG. 1, there is shown a diagram illustrating a system 100 in accordance with the present invention. As shown in FIG. 1, the system 100 includes at least one user device 102, illustrated in FIG. 1 as a personal computer. The user device 102 is used for illustration purposes only and the skilled artisan will appreciate that other user devices are equally capable of being implemented in accordance with the present invention. The user device 102 is operatively connected to a server 104 via a communications link 108. As will be understood by those skilled in the art, the communications link is any means for communication between electronic devices, including for example and without limitation, the Internet, a local area network, a wide area network, an Ethernet based connection, a Token Ring connection, infrared connection, Wi-Fi connection, telephone connection, cellular connection, Bluetooth connection and the like or any combination of communication means thereof. In the preferred embodiment, the system 100 includes multiple user devices, each of which are capable of accessing and the server 104 via a computer network, such as the Internet, local area network, wide area network, and the like.

The server 104 is in data communication with a storage medium 106. In the preferred embodiment, the storage medium 106 suitably comprises a document management system or document database. As will be appreciated by those skilled in the art, a document management system enables the creation, storage and tracking of multiple documents. In the preferred embodiment, the document management system includes multiple documents of varying formats. In accordance with the present invention, the user device 102 is capable of retrieving one or more electronic documents stored on the storage medium 106. The skilled artisan will appreciate that the storage medium 106 need not be separate from the server 104, and in the preferred embodiment, the storage medium 106 is suitably contained on the server 104. The storage medium 106 is any suitable form of data storage known in the art, including, but not limited to, hard disk drive storage, optical storage, flash memory and the like.

The user device 102 accesses the storage medium 106 over the communications link 108 and displays content via an associated graphical user interface, discussed more fully below. As is known in the art, the server 104 facilitates this data communication. Preferably, the user device 102 is authenticated prior to accessing the document management system of the storage medium 106, in accordance with any authentication process known in the art. Once accessed, the user device 102 is able to retrieve or store electronic documents on the storage medium 106. In one embodiment, the user device 102 suitably generates an electronic document using any word processing program known in the art, including, but not limited to Word® by Microsoft Corporation, WordPerfect® by Corel Corporation, and the like. The electronic document is then stored in the document management system on the storage medium 106. In the preferred embodiment, the server 104 is web-enabled and the user device 102 communicates with the server 104 via any suitable browser known in the art. As will be appreciated by those skilled in the art, the storage of an electronic document in a document management system requires the user to input one or more identifying elements, such as alphanumeric identifiers. Once stored on the system, the electronic document is suitably indexed and is thereby made available to other authorized users.

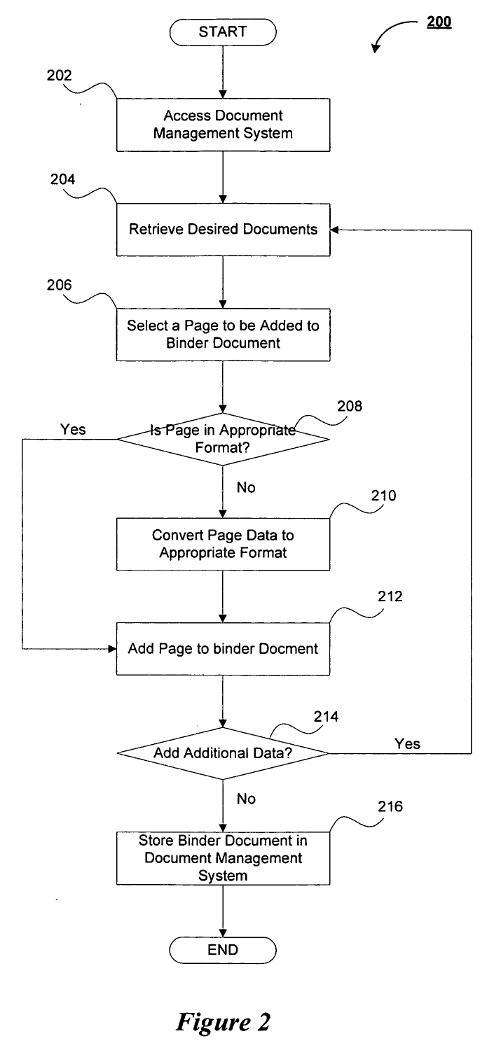

The present invention allows the user device 102 to retrieve one or more pages or documents from the storage medium 106 and view these pages or documents as images, such as icons, thumbnails, tiles, and the like. These images are then manipulated and moved about on the graphical user interface of the user device 102 to create a new electronic document. In accordance with the present invention, the images are contained within a document binder, which is then capable of being exported, printed, emailed, and stored as one document. As will be appreciated by those skilled in the art, the user device 102 establishes a connection with the document management system residing on the storage medium 106 via the browser. The user device 102 then requests one or more pages or documents, which are then displayed on the associated display of the user device 102. Via the associated display, the user is able to generate a new electronic document, composed of those pages or documents retrieved from the storage medium 106. The process by which the user device 102 generates new electronic documents will better be understood in connection with the method described in FIG. 2 below.

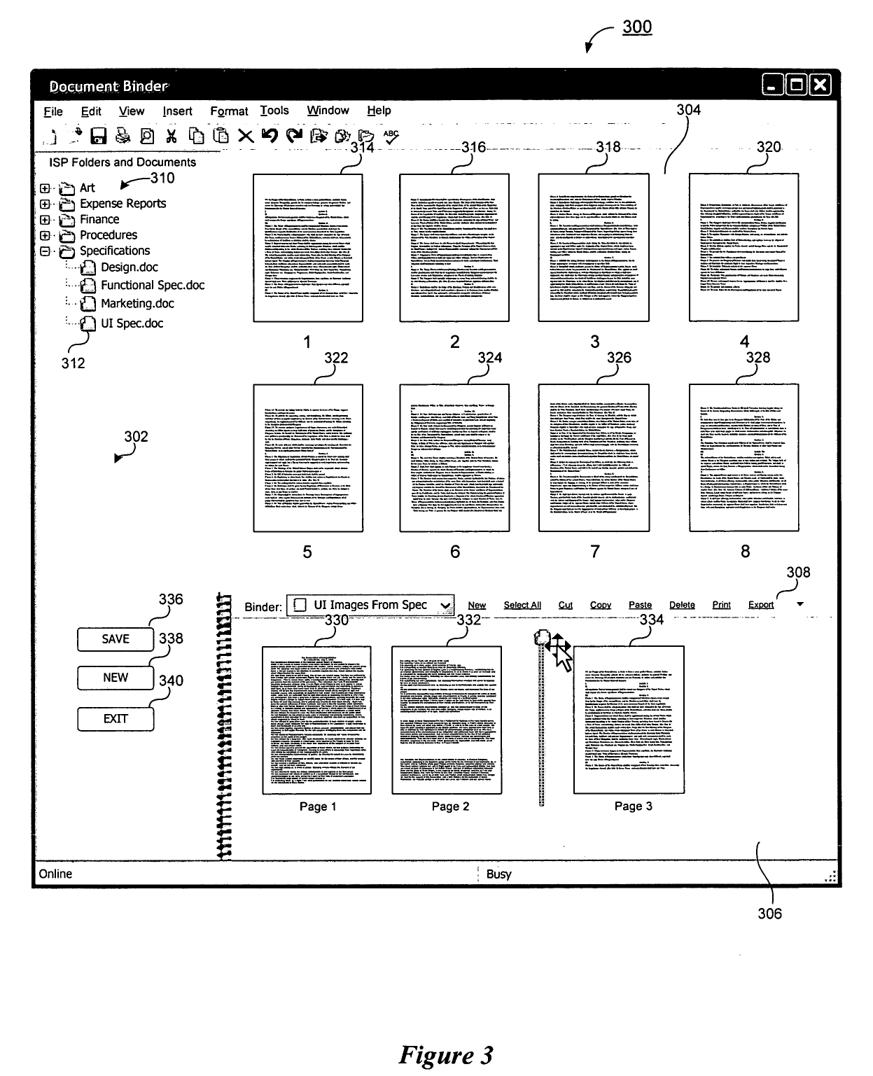

Turning now to FIG. 2, there is shown a flow chart 200 illustrating a method for generating a document binder in accordance with the present invention. The method begins at step 202 with the user, via the user device 102, accessing the document management system stored on the storage medium 106. As discussed above, the user device 102 accesses the document management system using a graphical user interface, preferably in the form of a web-based browser. It will be understood by those skilled in the art that any suitable interface, known in the art, is capable of being implemented in conjunction with the graphical user interface of the present invention. Preferably, the user device 102 is authenticated prior to accessing the storage medium 106. Once accessed, the user device 102 retrieves a document or documents from the document management system at step 204. The user device is also capable of extracting one or more pages of a document stored in the document management system in addition to retrieving whole documents. Each document and/or page retrieved from the document management system is displayed in the graphical user interface of the browser on the user device 102. This graphical user interface displayed on the user device 102 will be more fully discussed with respect to FIG. 3 below.

Once the document has been retrieved, the user selects an individual page or document to be added to the binder at step 206. Preferably, this selection is implemented, via the user interface, in a click and drag type of selection. Those skilled in the art will appreciate that indicia, such as for example and without limitation, icons, tiles, images, and the like, are displayed representing the original page or document. Therefore, a user selects an individual page or document by clicking on the image representing such a document or page and dragging the selected image to the binder. In an alternate embodiment, the present invention is capable of implementing standard menu driven selection processes, commonly referred to as cut and paste techniques. In one embodiment, both selection techniques are implemented, enabling the user to alternatively select which technique to use based upon user preference.

A determination is made at step 208 to determine whether the selected page or document is in the appropriate format. The skilled artisan will appreciate that the binder document being generated by the present invention uses a user selected document format, such as, tagged image file (TIFF) format, a modified modified read (MMR) format, a portable networks graphics (PNG) format, a portable document (PDF) format, and a joint picture experts group (JPEG) format. When the selected page or document is not in the same format as that of the binder document, for example, the selected page or document is in MS Word® format, flow proceeds to step 210, wherein the selected page or document is automatically converted to the same format as that of the binder document. The conversion to another document format is accomplished using any means known in the art for converting one file format to another file format.

Once converted to the appropriate format, the page or document is added to the binder document at step 212. When the selected page or document is already stored in the document management system in the same format as that of the binder document, flow proceeds to step 212, wherein the selected page or document is added to the binder document. Once added, a determination is made at step 214 whether another page or document is to be added to the binder. When additional pages or documents remain to be added, flow proceeds back to step 204 for selection of the next page or document, and the process continues as outlined above. When no further data, i.e., pages or documents, remain to be added to the binder document, flow proceeds to step 216, wherein the binder document is stored in the document management system.

The binder document is then accessible by the user or other users via the document management system. The binder document is then capable of being exported to the user device 102, transmitted via email, printed, and the like, as a single document. The system and method described above incorporate a graphical user interface, which facilitates user generation of binder documents. FIG. 3 depicts a template screen 300 illustrating an example graphical user interface in accordance with the system and method discussed above.

Referring now to FIG. 3, the screen 300 is suitably displayed on the user device 102 via a web-based browser or other suitable display means. As shown in FIG. 3, the screen 300 includes a display unit 302 illustrating the accessible contents of the document management system, a document viewing unit 304 illustrating the contents of a document in image format, and a binder viewing unit 306 illustrating the contents of the binder document. An expandable list of folders 310 is incorporated in the display unit 302, indicating the accessible content of the document management system. As shown, the folders 310 suitably include one or more main folders, or directories. Each of these folders preferably includes one or more documents. As illustrated in FIG. 3, the document 312 has been selected by the user and the contents, or pages of the document, are displayed in the document viewing unit 304. Each of the pages of the selected document 312 are displayed as tiles 314, 316, 318, 320, 322, 324, 326, and 328. The tiles are preferably image representations depicting the content of each corresponding page of the document. It will be understood by those skilled in the art that as each document is selected from within the folder list 310, the pages of the selected document are suitably displayed in the document viewing unit 304.

The binder viewing unit 306 displays those pages or documents contained in the binder document. Pages or documents that are selected by the user for incorporation into the binder document are illustrated in the binder viewing unit 306 as page images. As shown, the binder document includes three pages 330, 332 and 334. In the preferred embodiment, pages or documents are added to the binder document by clicking and dragging the page or document to the binder viewing unit 306. As indicated in FIG. 3, the subject invention enables standard menu driven techniques to be implemented as well. For example, the viewing unit 306 includes a menu 308, advantageously incorporating various edit commands, including cut and paste commands. Those skilled in the art will appreciate that such menu driven commands include, but art not limited to those commands illustrated in FIG. 3.

Once the user has finished adding pages to the new binder document, the user selects the save icon 336 to store the newly created binder in the document management system. The skilled artisan will appreciate the storage of the binder document incorporates the version controls, alphanumeric identifiers, and other indexing indicia, of the document management system. The user is further able to close the existing binder by selecting the exit icon 340, or to create a new, blank binder document by selecting the new icon 338. It will be appreciated by those skilled in the art that the graphical user interface of screen 300 enables a user to access a document management system, preferably via a browser, and create, edit, view, print, and download a document binder. Each binder suitably includes one or more images representing pages of the document.

The skilled artisan will further appreciate that the foregoing systems and methods are capable of employing authentication procedures as are known in the art. For example, the present invention is capable of being implemented such that only certain users are able to reserve paper trays and authentication procedures are suitably implemented to verify the user's rights to reserve a tray. In addition, the present invention is capable of being adapted to restrict different users to different reserve limitations, allowing one user or group of users to reserve a tray for one number of jobs or one period of time, while restricting another user or group of users to a lesser or greater number of jobs, or a shorter or longer period of time.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program, for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. An electronic document processor comprising:
means adapted for receiving electronic document data including data representative of a plurality of pages to be rendered on an associated output device;
means adapted for displaying indicia representative of the plurality of pages on an associated display;
means adapted for generating an image representative of a document binder on the associated display;
user interface means adapted for receiving, from an associated user, arrangement instructions relative to selective assembly of the plurality of pages relative to the document binder;
display means adapted for generating a display image representative of the selective assembly of the plurality of pages relative to the document binder;
conversion means adapted for converting data representative of the assembly of the plurality of pages relative to the document binder into binder data comprising a selected document output format;
means adapted for receiving a document output instruction from an associated user; and
means adapted for communicating the output data to an associated document rendering device in connection with a received document output instruction.

2. The electronic document processor of claim 1, wherein the arrangement instructions are acquired via a drag and drop user interface.

3. The electronic document processor of claim 1, wherein the arrangement instructions are acquired via a cut and paste user interface.

4. The electronic document processor of claim 1, further comprising means adapted for generating a plurality of binder data sets from the plurality of pages of the electronic document data.

5. The electronic document processor of claim 4, wherein the at least one of the plurality of binder data sets are nested in another binder data set, and wherein the display means includes means adapted for generating a display representative of at least one nested binder set.

6. The electronic document processor of claim 1, wherein the electronic document data is received from an associated document management system.

7. The electronic document processor of claim 1, further comprising storage means adapted for storing the output data in an associated document management system.

8. The electronic document processor of claim 1, wherein the selected document output format is one of the group consisting of a tagged image file format, a modified modified read format, a portable networks graphics format, a portable document format, and a joint picture experts group format.

9. A method for manipulating electronic document data comprising the steps of:
receiving electronic document data including data representative of a plurality of pages to be rendered on an associated output device;
displaying indicia representative of the plurality of pages on an associated display;
generating an image representative of a document binder on the associated display;
receiving, from an associated user via a user interface, arrangement instructions relative to selective assembly of the plurality of pages relative to the document binder;
generating a display image representative of the selective assembly of the plurality of pages relative to the document binder;
converting data representative of assembly of the plurality of pages relative to the document binder into binder data comprising a selected document output format;
receiving a document output instruction from an associated user; and
communicating the output data to an associated document rendering device in connection with a received document output instruction.

10. The method for manipulating electronic document data of claim 9, wherein the arrangement instructions are acquired via a drag and drop user interface.

11. The method for manipulating electronic document data of claim 9, wherein the arrangement instructions are acquired via a cut and paste user interface.

12. The method for manipulating electronic document data of claim 9, further comprising the step of generating a plurality of binder data sets from the plurality of pages of the electronic document data.

13. The method for manipulating electronic document data of claim 12, wherein the at least one of the plurality of binder data sets are nested in another binder data set, further comprising the step of generating a display representative of at least one nested binder set.

14. The method for manipulating electronic document data of claim 9, wherein the electronic document data is received from an associated document management system.

15. The method for manipulating electronic document data of claim 9, further comprising the step of storing the output data in an associated document management system.

16. The method for manipulating electronic document data of claim 9, wherein the selected document output format is one of the group consisting of a tagged image file format, a modified modified read format, a portable network graphics format, a portable document format, and a joint picture experts group format.

17. A computer-readable medium of instructions with computer-readable instructions stored thereon for manipulating electronic document data comprising:
instructions for receiving electronic document data including data representative of a plurality of pages to be rendered on an associated output device;
instructions for displaying indicia representative of the plurality of pages on an associated display;
instructions for generating an image representative of a document binder on the associated display;
instructions for receiving, from an associated user via a user interface, arrangement instructions relative to selective assembly of the plurality of pages relative to the document binder;
instructions for generating a display image representative of the selective assembly of the plurality of pages relative to the document binder;
instructions for converting data representative of assembly of the plurality of pages relative to the document binder into binder data comprising a selected document output format;
instructions for receiving a document output instruction from an associated user; and
instructions for communicating the output data to an associated document rendering device in connection with a received document output instruction.

18. The computer-readable medium of instructions with computer-readable instructions stored thereon for manipulating electronic document data of claim 17, wherein the arrangement instructions are acquired via one of the group consisting of a drag and drop user interface and a cut and paste user interface.

19. The computer-readable medium of instructions with computer-readable instructions stored thereon for manipulating electronic document data of claim 17, further comprising instructions for generating a plurality of binder data sets from the plurality of pages of the electronic document data.

20. The computer-readable medium of instructions with computer-readable instructions stored thereon for manipulating electronic document data of claim 19, wherein the at least one of the plurality of binder data sets are nested in another binder data set, further comprising instructions for generating a display representative of at least one nested binder set.

21. The computer-readable medium of instructions with computer-readable instructions stored thereon for manipulating electronic document data of claim 17, wherein the electronic document data is received from an associated document management system.

22. The computer-readable medium of instructions with computer-readable instructions stored thereon for manipulating electronic document data of claim 17, further comprising instructions for storing the output data in an associated document management system.

23. The computer-readable medium of instructions with computer-readable instructions stored thereon for manipulating electronic document data of claim 17, wherein the selected document output format is one of the group consisting of a tagged image file format, a modified modified read format, a portable network graphics format, a portable document format, and a joint picture experts group format.

24. A computer-implemented method for manipulating electronic document data comprising the steps of:
receiving electronic document data including data representative of a plurality of pages to be rendered on an associated output device;
displaying indicia representative of the plurality of pages on an associated display;
generating an image representative of a document binder on the associated display; receiving, from an associated user via a user interface, arrangement instructions relative to selective assembly of the plurality of pages relative to the document binder;
generating a display image representative of the selective assembly of the plurality of pages relative to the document binder;
converting data representative of assembly of the plurality of pages relative to the document binder into binder data comprising a selected document output format;
receiving a document output instruction from an associated user; and
communicating the output data to an associated document rendering device in connection with a received document output instruction.

25. The computer-implemented method for manipulating electronic document data of claim 24, wherein the arrangement instructions are acquired via one of the group consisting of a drag and drop user interface and a cut and paste user interface.

26. The computer-implemented method for manipulating electronic document data of claim 24, further comprising the step of generating a plurality of binder data sets from the plurality of pages of the electronic document data.

27. The computer-implemented method for manipulating electronic document data of claim 26, wherein the at least one of the plurality of binder data sets are nested in another binder data set, further comprising the step of generating a display representative of at least one nested binder set.

28. The computer-implemented method for manipulating electronic document data of claim 24, wherein the electronic document data is received from an associated document management system.

29. The computer-implemented method for manipulating electronic document data of claim 24, further comprising the step of storing the output data in an associated document management system.

30. The computer-implemented method for manipulating electronic document data of claim 24, wherein the selected document output format is one of the group consisting of a tagged image file format, a modified modified read format, a portable network graphics format, a portable document format, and a joint picture experts group format.
